(19) United States
(12) Patent Application Publication
(10) Pub. No.: US 2013/0176138 A1
(43) Pub. Date: Jul. 11, 2013

(54) APPARATUS AND METHOD FOR ENHANCING SUBSURFACE SURVEYS

(71) Applicant: Peter S. Aronstam, Houston, TX (US)

(72) Inventor: Peter S. Aronstam, Houston, TX (US)

(21) Appl. No.: 13/811,214

(22) PCT Filed: Jul. 20, 2011
(86) PCT No.: PCT/US2011/044762

§ 371 Date: Mar. 20, 2013

Related U.S. Application Data
(60) Provisional application No. 61/366,227, filed on Jul. 21, 2010.

(51) Int. Cl. G01V 3/34

(52) U.S. Cl. CPC G01V 3/34
USPC 340/854.3

(57) ABSTRACT

This invention generally relates to the field of 2D, 3D and 4D survey techniques used to delineate the subsurface structure of the earth. In one aspect, a method of using a downhole system is provided. The method includes the step of deploying the downhole system in a wellbore. The method further includes the step of allowing wellbore fluid to move through the down-hole system. Additionally, the method includes the step of selectively generating signals in the downhole system that are used in subsurface surveys. In another aspect, a downhole system for use in generating signals in a wellbore that are used in subsurface surveys is provided.

### BACKGROUND OF THE INVENTION

1. Field of the Invention

This invention relates to the field of 2D, 3D and 4D survey techniques used to delineate the subsurface structure of the earth. More particularly, the invention relates to survey techniques used in flowing wells.

2. Description of the Related Art

In 3D and 4D surveying, a series of sources and receivers are placed in a regular array on the surface above the subsurface target of interest. Most commonly, these sources and receivers use either acoustic or electromagnetic technology. Both technologies are appropriate to map and interpret the subsurface. Over the years it has been shown that including some subsurface receivers/sources can greatly enhance the survey result. Having this additional information improves the depth accuracy, increases the stability of many imaging algorithms, and can correct for lateral smearing due to limited viewing aperture from the surface.

However, in active oilfields, the production has to be stopped in order to deploy the surveying equipment in the wellbore. Thus, the cost of interrupting production and installing such subsurface sources and receivers prevents the method from being widely practiced.

### SUMMARY OF THE INVENTION

This invention generally relates to the field of 2D, 3D and 4D survey techniques used to delineate the subsurface structure of the earth. In one aspect, a method of using a downhole system is provided. The method includes the step of deploying the downhole system in a wellbore. The method further includes the step of allowing wellbore fluid to move through the downhole system. Additionally, the method includes the step of selectively generating signals in the downhole system that are used in subsurface surveys.

In another aspect, a downhole system for use for generating signals in a wellbore that are used in subsurface surveys is provided. The system includes a power generation module for autonomously generating power using well fluids moving through the wellbore. The system further includes a communication module for selectively generating and sending the signals. Additionally, the system includes a controller controlling the communication module, wherein each module includes a bore to allow production of well fluids.

In yet a further aspect, a method of using a downhole system for generating signals in a wellbore that are used in subsurface surveys is provided. The method includes the step of attaching the downhole system in the wellbore. The method also includes the step of autonomously generating power in the downhole system using fluid flow through the wellbore. Further, the method includes the step of selectively generating signals for use in subsurface surveys and transmitting the signals to a receiver on a surface of the wellbore.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a view of a downhole system for use in a wellbore.

FIG. 2 illustrates a view of the system transmitting data to a surface receiver.

FIGS. 3a-3c illustrate different views the system.

FIG. 4 illustrates a view of a power generation module in the system.

FIG. 5 illustrates an example of acoustic subsurface imaging methods.

FIG. 6 illustrates a view of the system with acoustic subsurface imaging.

FIG. 7 illustrates an example of electromagnetic imaging methods.

FIG. 8 illustrates a view of the system with electromagnetic imaging.

### DETAILED DESCRIPTION

The present invention provides a system and method to allow the placement of subsurface sources and receivers for 2D, 3D and 4D surveys. The apparatus of the present invention provides a self-powered, autonomous, flow-through system for use in the borehole that is capable of emitting and receiving signals appropriate for subsurface surveying.

Such a system might be permanently deployed in a wellbore for primarily other purposes, such as temperature and pressure measurement, yet have on board the necessary hardware and software to participate in occasional surveys in the area. In one embodiment, the normal mode of communication of other information to the surface may be used as an input data to a subsurface survey and image. To better understand the novelty of the system of the present invention and the methods of use thereof, reference is hereafter made to the accompanying drawings.

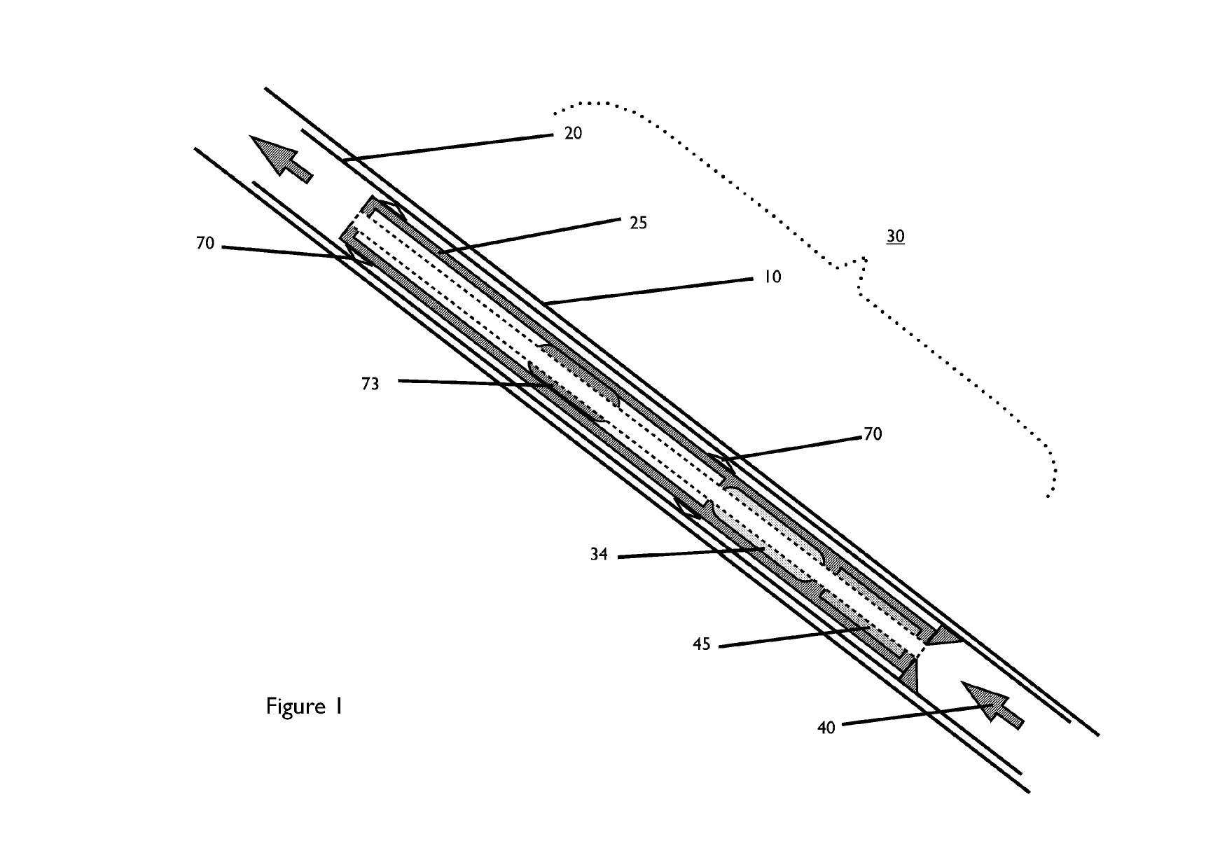

FIG. 1 illustrates a view of a downhole system 30 for use in a wellbore. The system 30 consists of several modules which are contained within an outer housing 25. The outer housing 25 is held in place inside a production tubing 20 by gripping members 70 which are energized on installation. The production tubing 20 is disposed within well casing 10. In another embodiment, the system 30 can be affixed directly to the well casing 10. The entire system 30 is autonomous and operates without any direct connectivity to the surface of the wellbore.

Within the outer housing 25 are a series of modules which in concert provide the necessary functions for the system 30. In the embodiment shown, the modules are: a communication module 73, a controller, sensor and power storage module 34, and a power generation module 45. All of the modules are designed so that fluid 40 can flow through the modules within the system 30, minimally impeding the flow, such as not to interfere with production from the well.

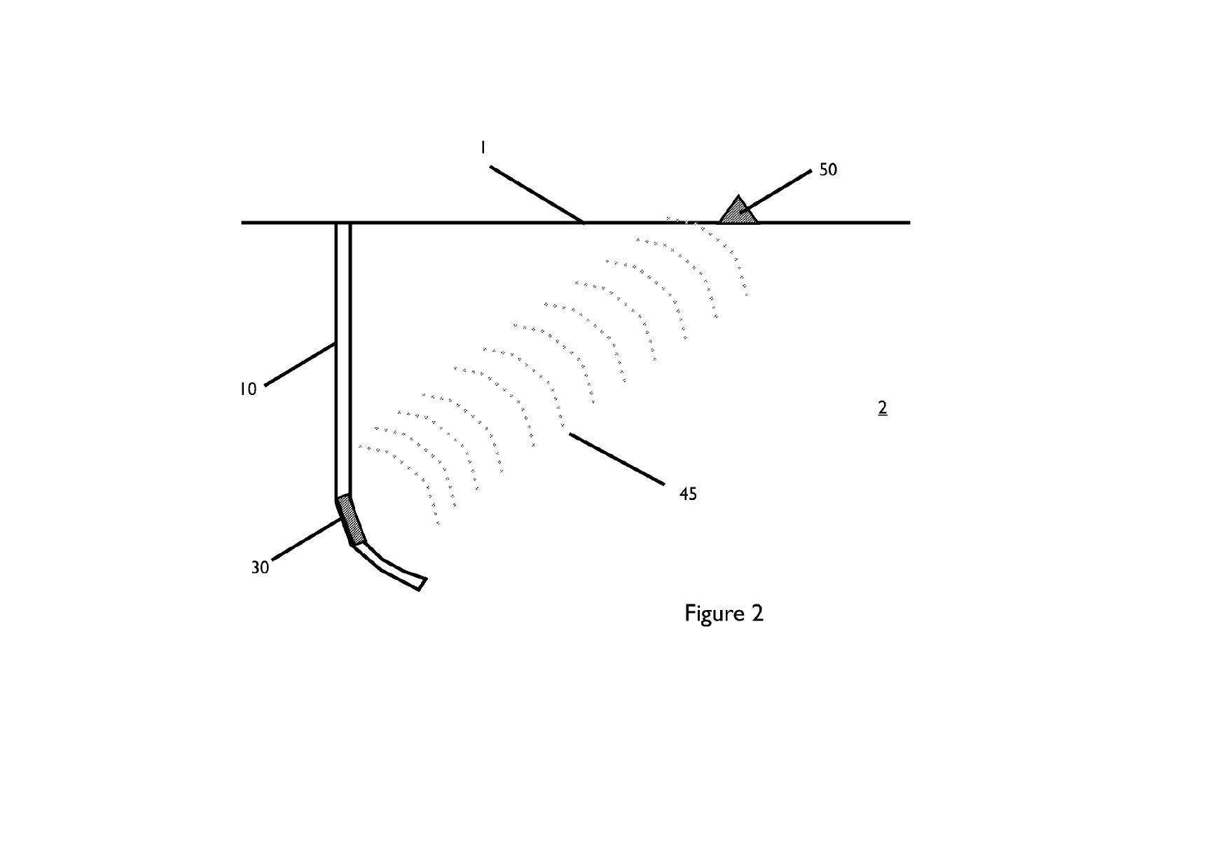

FIG. 2 is a view illustrating the system 30 transmitting data to a surface receiver 50. The system 30 may be configured to provide many different functions in the well environment. For example, the system 30 may be configured to measure temperature and pressure in the well and transmit the data to the surface on some schedule. As shown in FIG. 2, the system 30 is installed in wellbore 10. The system 30 is programmed to make measurements which are then transmitted through the earth as electro-magnetic (e/m) waves 45 to a surface receiver 50 for recording and interpretation by the well owner. It may also be possible to instruct the controller within the system 30 to emit specially encoded signals which could be used for the purpose of evaluating the earth properties along the communication path.

In a further embodiment, the mechanical action of the power generation module 45 in FIG. 1 can be programmed to emit acoustic waves which would also travel out into the earth. One such method would be to vary the loading on the generator in the power generation module 45 with some known pseudo-random pattern which could be recorded and recovered in a distant receiver. The key difference between this system 30 and previous borehole sources is the fact that the well can continue production simultaneously with performing these other functions. In other words, the system 30 may be deployed in the wellbore and remain in the wellbore prior to production and during production.

In yet a further embodiment, the system 30 could be equipped with a receiver allowing the emission of waves to be synchronized for use in surveys as will be discussed herein.

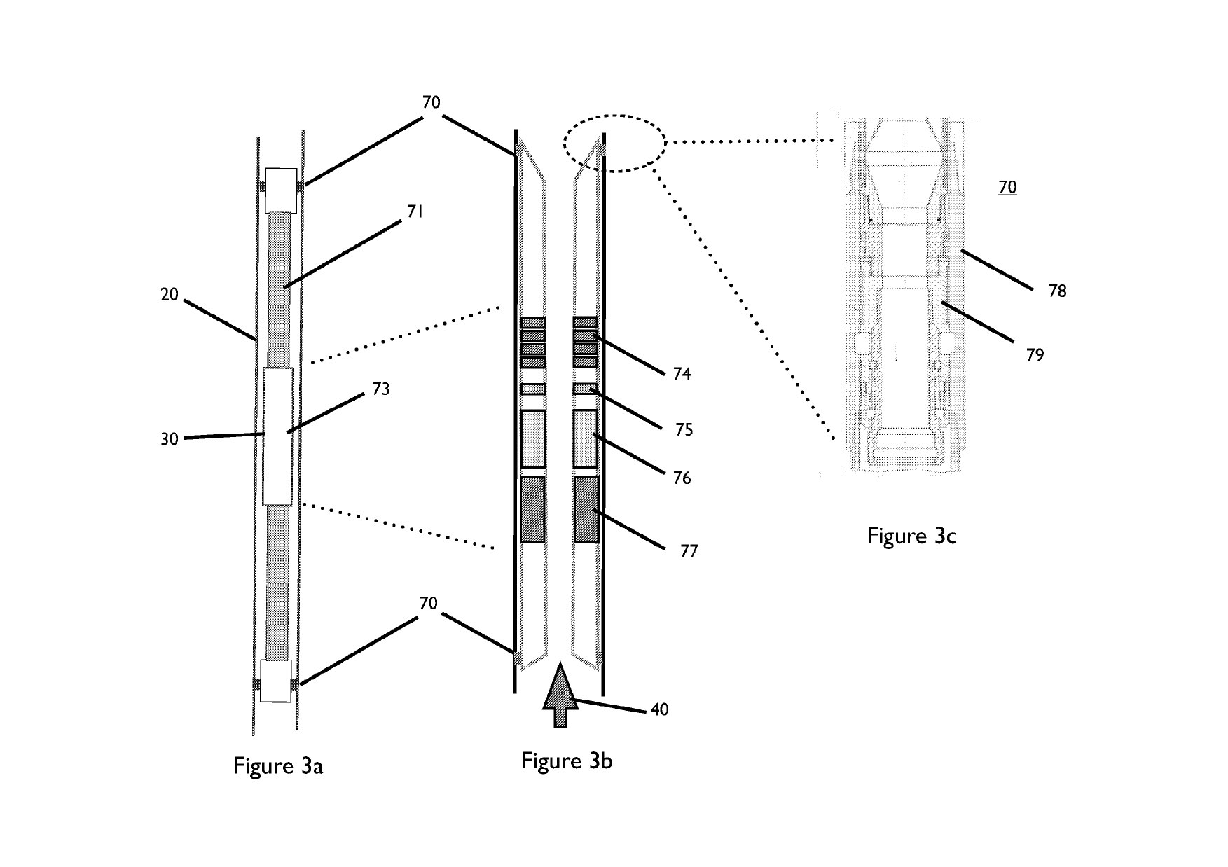

FIGS. 3a-3c are views illustrating the system 30. FIG. 3a illustrates an exterior view of the system 30 and its components. Each end of a body 71 of the system 30 is affixed to the production tubular 20 by gripping members 70. Located centrally along the body 71 is the communication module 73. FIG. 3b illustrates an enlarged view of the communication module 73. The transmitting transformers 74 and receiving transformers 75 are located within the communication module 73. The transformers 74, 75 are connected to a transceiver 76. The communication module 73 may also include a power storage system 77. All of the subsystems within the communication module 73 as well as the body 71 include a bore for allowing well fluid 40 to pass through the system 30 with minimum obstruction.

FIG. 3c is a view of one embodiment of the gripping members 70 which can be used to hold the system 30 in place. The gripping members 70 include the locking mechanism 79 and slips 78 which are configured to engage the well tubular 20 (or wellbore). Such gripping members 70 are well known in the art and are used for hanging off components in wellbores such as straddle packers. The operative difference is that the slips 78 are isolated electrically from the remainder of the body 71 to prevent shorting of the signal through the body 71. Due to the fact that the system 30 may reside within the well for many years, the slips 78 may be plated with gold or other conducting metal which resists corrosion, which might change the quality of the electrical contact.

The uppermost gripping member 70 may also contain a mating socket which allows the entire system 30 to be deployed and retrieved by wireline or coil tubing.

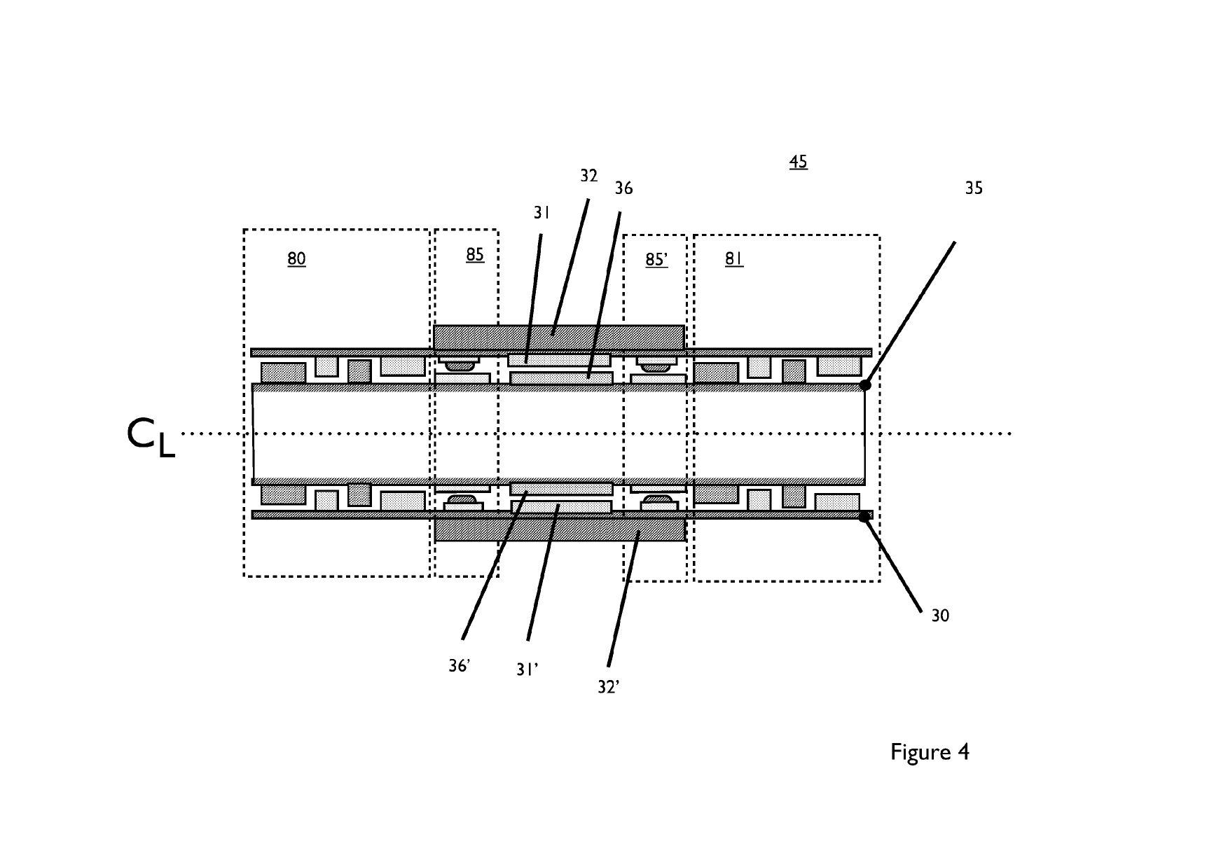

FIG. 4 illustrates a view of the power generation module 45. The generator in the power generation module 45 consists of inner 35 and outer 30 shells which are free to rotate with respect to each other. The outer 30 and inner 35 shells are axially supported by magnetic bearings 80, 81 and radially stabilized by diamond bearings 85, 85′. Electricity is generated by a series of coils 36 and magnets 31 arrayed radially around the outer 30 and inner 35 shells, respectively. The outer shell 30 is driven (e.g., rotated) by fluid pressure acting on vanes 32. An example of a generator is described in U.S. patent application Ser. No. 13/185,418 filed on Jul. 18, 2011 and entitled METHOD AND APPARATUS FOR HYBRID SUSPENSION SYSTEM, which is incorporated herein by reference in its entireity.

All rotating machinery produces some noise due to bearings and slight manufacturing imbalances. Such noises have been used to track and evaluate near bore properties in the past. Of greater use is to start and stop the rotation by changing the load on the coils of the generator in the power generation module 45. This causes a stutter in the rotating element which emits acoustic noise. By programming the variation of load on the generator, it would be possible to generate a coded signal which can be received and decoded at great distance. This would give the system 30 the ability to emit acoustic as well as electromagnetic waves into the earth, which can be used for other than communication purposes.

Alternatively, an acoustic generator module could be constructed using magnetic coil technology and appended to the system (not illustrated).

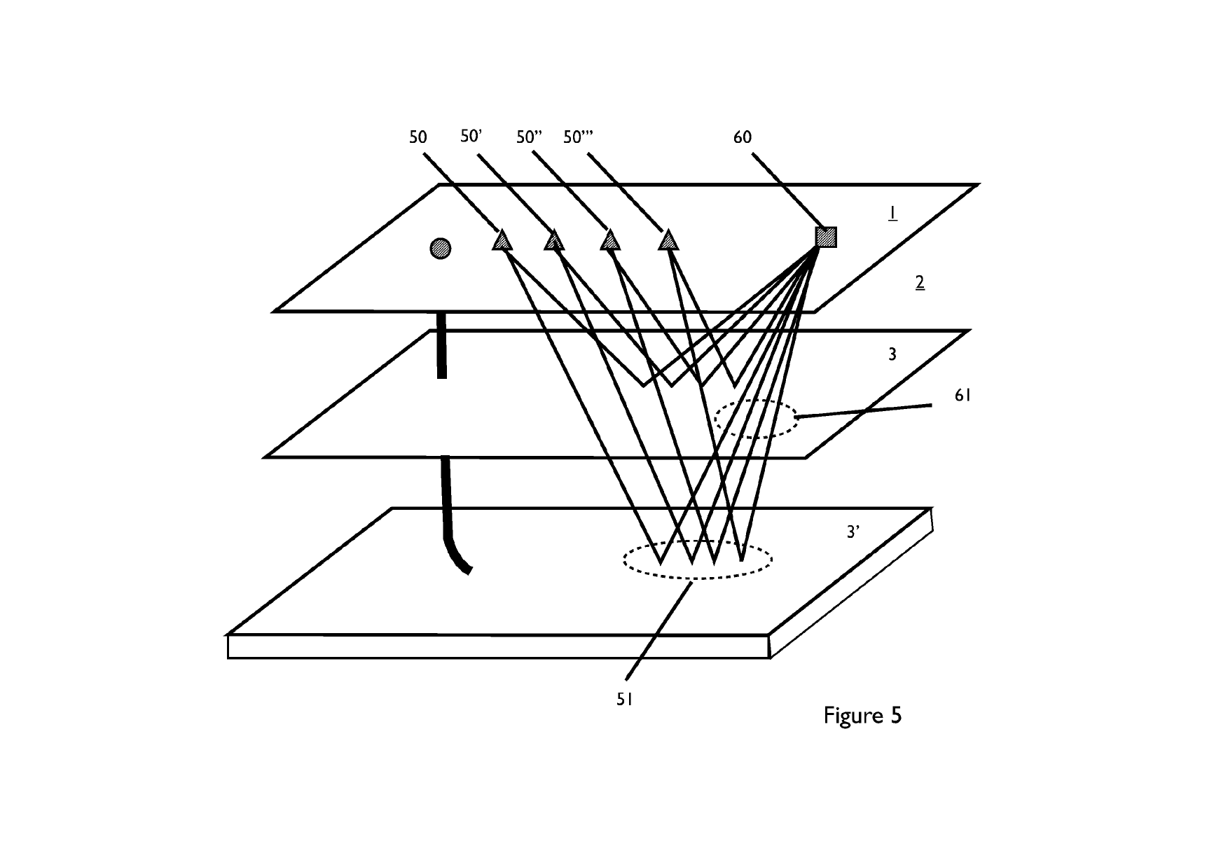

FIG. 5 illustrates an example acoustic subsurface imaging. Sources 60 and receivers 50 are placed on a surface 1, sea floor, or towed in the ocean above the ground surface 1. Acoustic signals 61 emitted from the source 60 travel through the subsurface 2, reflecting off acoustic discontinuities 3, 3′ caused by variations in rock properties. A portion of the energy reflected form the acoustic discontinuities 3, 3′ is returned to the surface 1 and is recorded by receivers 50, 50′, etc. Through data reduction and processing, it is possible to construct an image of the areas covered by the reflection points 51.

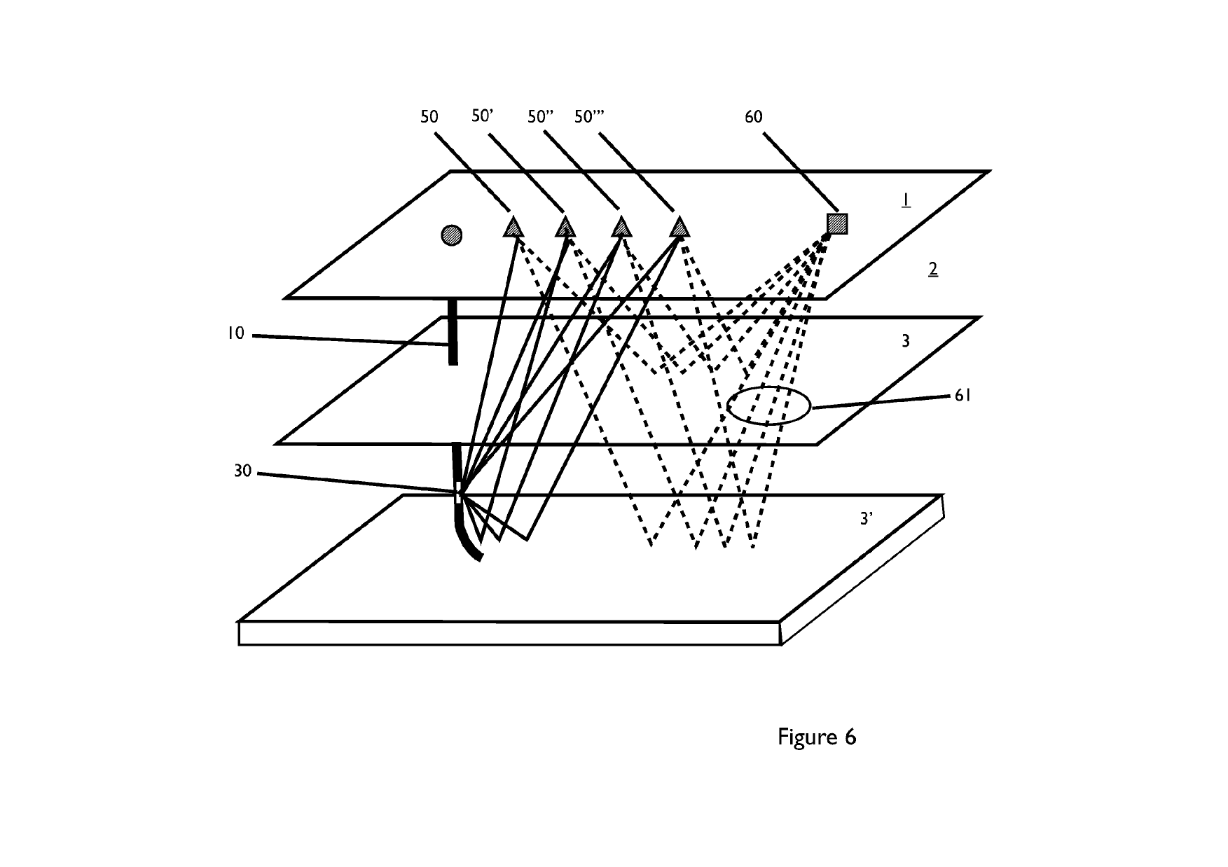

By including the acoustic emissions described above, it is possible to augment 2D, 3D, and 4D acoustic surveys. This is illustrated in FIG. 6. A survey is conducted over surface 1 for the purpose of illuminating the subsurface structure. By the addition of the acoustic emissions for the system 30, it is possible to extend the subsurface coverage. One of the great weaknesses of surface methods is that data received has traveled two ways, down and up, in the subsurface. Therefore assumptions on the properties of upper layers affect the evaluation and reconstruction of layers below. By utilizing the direct ray emissions from the system 30 it is possible to record direct ray paths which can reduce this uncertainty.

It is also well known that reconstruction algorithms are more robust if the individual cells in the reconstruction are traversed by energy in many directions. Again, using the emission from the system 30 allows us to provide such improvements.

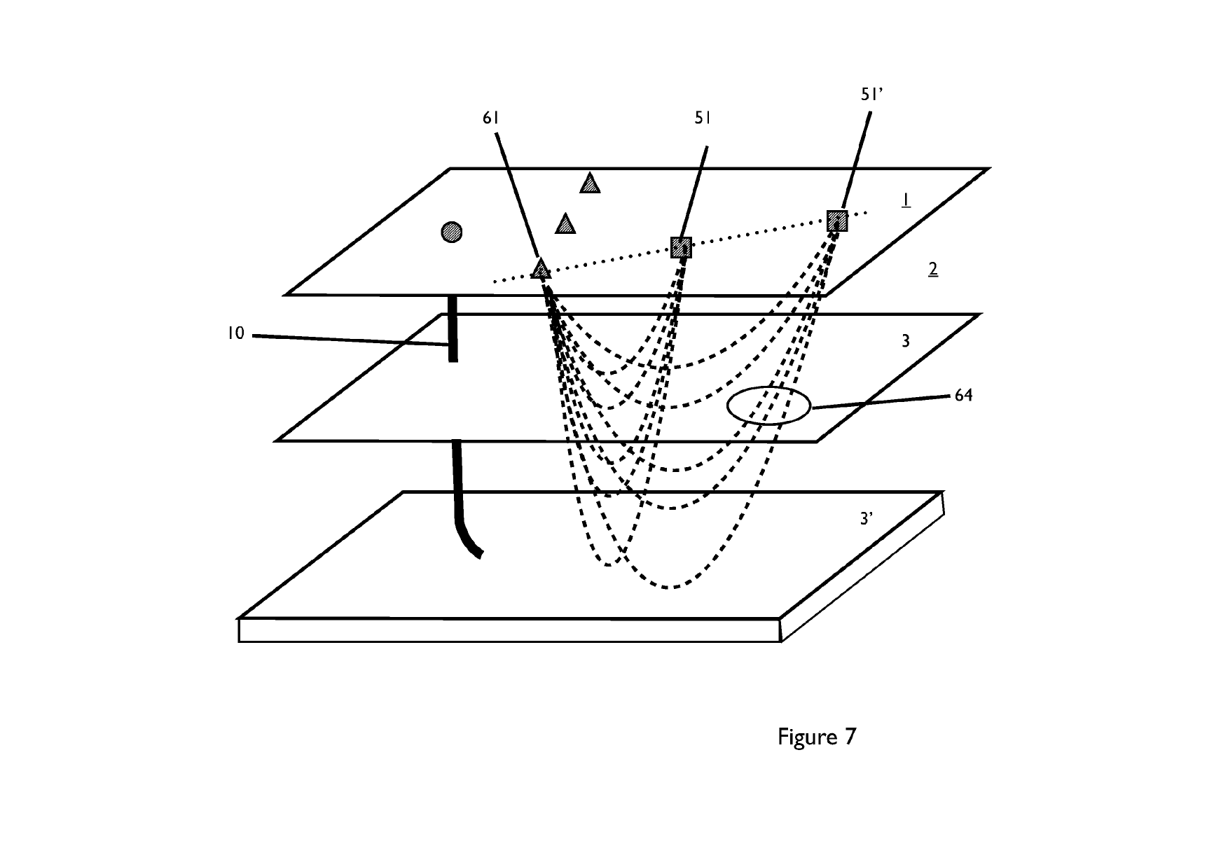

FIG. 7 shows the ground 1 being surveyed using electromagnetic methods. Electromagnetic methods are slightly more complex than acoustic methods. The complication is the electric current which flows along all paths 64 between a given source 61 and the several surface receivers 51 51′. However, methods are well known in the art to allow images to be reconstructed from such data. Once again, however, the fact that all the observations are made from the surface can lead to depth errors as smearing of the image (lateral errors).

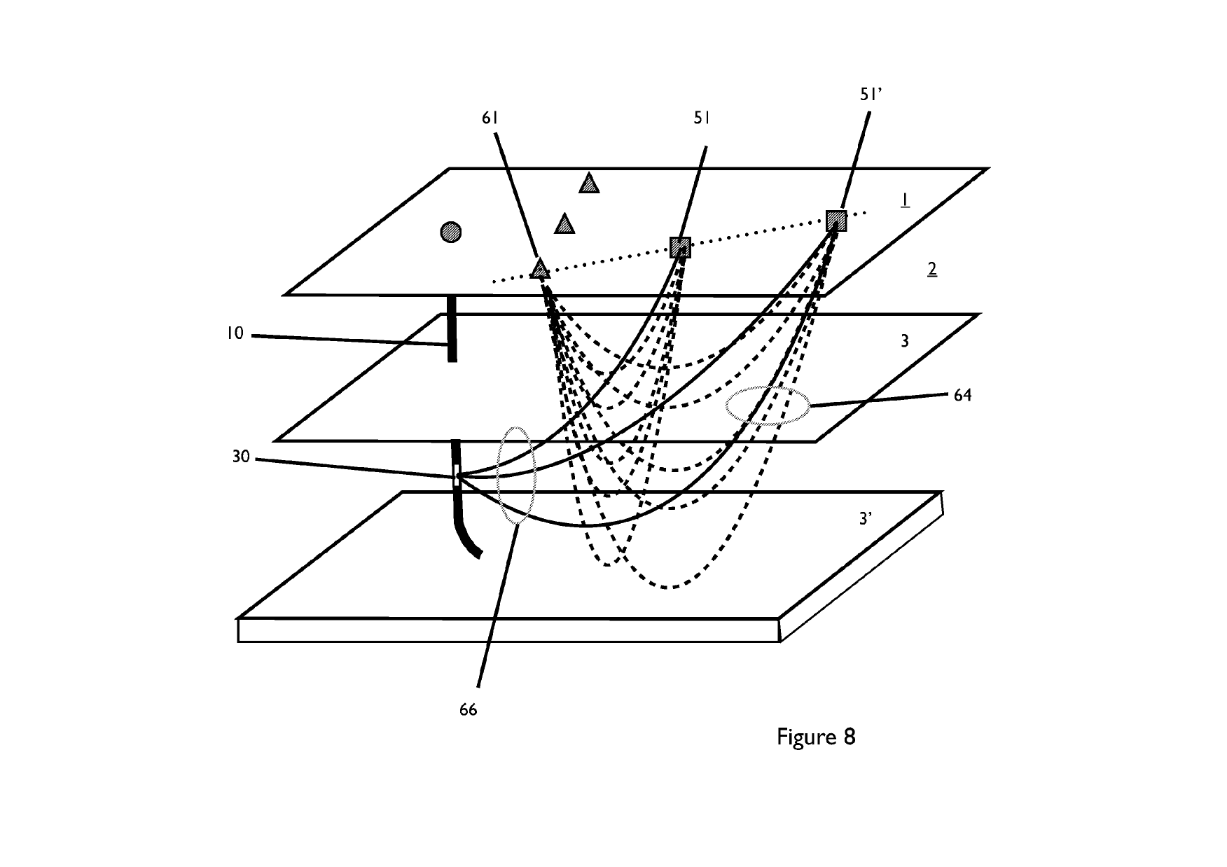

FIG. 8 is a view of the system 30 with electromagnetic imaging. As described in relation to FIG. 2, the electric current flows along all paths 64 between a given source 61 and the several surface receivers 51 51′. However, methods are well known in the art to allow images to be reconstructed from such data. FIG. 8 shows the same survey geometry, but now the data from the electro-magnetic transmitter of system 30 are available and recorded. Just as in acoustic imaging, this data can be used to improve the depth accuracy and robustness of the reconstruction. As with the acoustic case, the signals device is beneficial in 2D, 3D, and 4D surveys. One such method for 4D application is described in U.S. Pat. No. 6,739,165.

With the increase in the number of multilateral wells, the likelihood that a well might have more than one such system 30 deployed improves the situation even further (not illustrated). One step further, with many wells, common in offshore fields, it might even be possible to monitor changes within the reservoir using only the data transmitted and received by the plurality of deployed systems 30. An example of such monitoring methods is described in U.S. Pat. No. 5,886,255.

In one aspect, an autonomous downhole apparatus is provided. The apparatus includes a power generation means, a controller means, an electromagnetic transmitter means and a through bore clearance to allow production of well fluids. In another embodiment, the apparatus includes a receiver means. In a further embodiment, the power means also contains a storage means. In another embodiment, the apparatus is permanently installed in the wellbore. In a further embodiment, the apparatus is temporarily deployed and recovered by wireline. In another embodiment, the apparatus is temporarily deployed and recovered by coil tubing. In another embodiment, the electromagnetic signals are received from one or more devices during the conducting of 3D electro-magnetic surveys. In another aspect, the apparatuses are disposed in a plurality of wells within the survey area. In another embodiment, e/m emissions are unscheduled by the e/m survey surface controller. In another embodiment, e/m emissions are scheduled by the e/m survey surface controller. In another embodiment, the purpose of receiving the subsurface e/m signal is calibration of the surface array. In another embodiment, the purpose of receiving the subsurface e/m signal is depth calibration. In a further embodiment, the purpose of receiving the subsurface e/m signal is image enhancement or image correction of the processed surface data. In an additional embodiment, the purpose of receiving the subsurface e/m signal is image formation. In yet another embodiment, the purpose of receiving the subsurface e/m signal is 4D measurement.

Although the descriptions above contain many specifications, these should not be construed as limiting the scope of the invention but as merely providing illustrations of some of the presently preferred embodiments of this present invention. Persons skilled in the art will understand that the method and apparatus described herein may be practiced, including but not limited to, the embodiments described. Further, it should be understood that the invention is not to be unduly limited to the foregoing, which has been set forth for illustrative purposes. Various modifications and alternatives will be apparent to those skilled in the art without departing from the true scope of the invention, as defined in the following claims. While there have been illustrated and described particular embodiments of the present invention, it will be appreciated that numerous changes and modifications will occur to those skilled in the art, and it is intended in the appended claims to cover those changes and modifications which fall within the true spirit and scope of the present invention.

While the foregoing is directed to embodiments of the present invention, other and further embodiments of the invention may be devised without departing from the basic scope thereof, and the scope thereof is determined by the claims that follow.

1. A method of using a downhole system, the method comprising:
deploying the downhole system in a wellbore;
allowing wellbore fluid to move through the downhole system; and
selectively generating signals in the downhole system that are used in subsurface surveys.

2. The method of claim 1, further comprising autonomously generating power in the downhole system using wellbore fluid.

3. The method of claim 1, wherein the system is configured to generate signals while fluid flow moves through the wellbore and the downhole system.

4. The method of claim 1, wherein the downhole system is temporarily deployed and recovered by wireline.

5. The method of claim 1, wherein the signals generated by the downhole system are scheduled by a survey controller disposed on a surface of the wellbore.

6. The method of claim 1, further comprising measuring temperature data or pressure data in the wellbore and transmitting the measured data to a surface of the wellbore.

7. The method of claim 1, wherein the signals generated by the downhole system are used in the calibration of a surface array used in subsurface surveys.

8. The method of claim 1, wherein the signals generated by the downhole system are used in depth calibration.

9. The method of claim 1, wherein the signals generated by the downhole system are used to enhance an image of a subsurface survey generated by transmitters and receivers on a surface of the wellbore.

10. The method of claim 1, wherein the signals generated by the downhole system are used to generate a subsurface survey image.

11. The method of claim 1, wherein the signals generated in the downhole system are electromagnetic signals.

12. The method of claim 1, wherein the signals generated in the downhole system are acoustic signals.

13. A downhole system for use in generating signals in a wellbore that are used in subsurface surveys, the system comprising:
a power generation module for autonomously generating power using well fluids moving through the wellbore;
a communication module for selectively generating and sending the signals; and
a controller controlling the communication module, wherein each module includes a bore to allow production of well fluids.

14. The downhole system of claim 13, wherein the power generation module includes a generator and wherein changing the load on the generator emits acoustic signals.

15. The downhole system of claim 13, wherein the communication module includes a power storage member for storing power generated by the power generation module.

16. The downhole system of claim 13, further comprising gripping members configured to support the downhole system within the wellbore.

17. The downhole system of claim 13, further comprising sensors for measuring temperature or pressure in the wellbore.

18. The downhole system of claim 13, wherein the communication module includes transmitting transformers, receiving transformers and a transceiver.

19. The downhole system of claim 13, wherein the signals generated by the communication module are scheduled by a survey controller disposed on a surface of the wellbore.

20. A method of using a downhole system for generating signals in a wellbore that are used in subsurface surveys, the method comprising:
attaching the downhole system in the wellbore;
autonomously generating power in the downhole system using fluid flow through the wellbore; and
selectively generating signals for use in subsurface surveys and transmitting the signals to a receiver on a surface of the wellbore.

21. The method of claim 20, wherein the signals generated by the downhole system are scheduled by a survey controller disposed on the surface of the wellbore.
